(19) United States
(12) Patent Application Publication
(10) Pub. No.: US 2009/0303052 A1
(43) Pub. Date: Dec. 10, 2009

(54) FRESHNESS TRACKING AND MONITORING SYSTEM AND METHOD

(76) Inventors: ALEXANDER AKLEPI, Miami, FL (US); BENJAMIN MOISES ROSALES KIVILEVITZ, Key Biscayne, FL (US); VLADIMIR LEVEDEV, Hallandale, FL (US); LEONARDO ARMANDO CIPRIANI, Weston, FL (US); LUIS ERNESTO GONZALEZ, Weston, FL (US)

Correspondence Address: INTELLECTUAL PROPERTY BUSINESS CONSULTANTS, PLLC;Attn: Dr. Mario Sergio Golab, 1413 SANTA CRUZ AVE, CORAL GABLES, FL, 33134-2257, US

(21) Appl. No.: 12/136,031

(22) Filed: Jun. 9, 2008

(51) Int. Cl. G08B 23/00; G08B 21/00

(52) U.S. Cl. 340/573.2; 340/540; 340/584

(57) ABSTRACT

A freshness tracking and monitoring system (“System”) and method used for ensuring the freshness of perishable goods, goods fit for human consumption, and final products made from perishable good or goods fit for human consumption (“Items”). The System monitors in a continuous manner all significant environment and transportation parameters associated with an Item, from harvest or production until acquisition for consumption or production, alerts when an Item's monitored variable exceeds a predetermined parameter, takes corrective actions while in transportation, and provides advice about possible changes in the nature of the Item.

### BACKGROUND OF THE INVENTION

1. Field of the Invention

This invention generally relates to a system and method for tracking, monitoring, and ensuring the freshness, from production to consumption, of perishable goods, goods fit for human consumption, and final products made from perishable goods and/or goods fit for human consumption (“Items”). More particularly, this invention relates to a system that monitors, in a continuous manner, all significant environment and transportation parameters of an Item, from harvest or production until acquisition for consumption or production, provides visual and remote alerts when a monitored Item's variable exceeds a predetermined parameter, takes intelligent corrective actions while the Items are in transportation containers, dynamically adjusts and denotes an Item's useful life, provides visual and remote notification about variations in an Item's measured parameter, and provides advice about possible changes in the nature of the item (“System”).

2. Description of Related Prior Art

Since time immemorial, humans were concerned with the freshness and edibility of perishable products and products used for integration into other products used for consumption.

Traditionally, consumers relayed on a variety of methods to ensure that an Item was fresh including, for example and without limitations, maintaining the Item refrigerated, trusting a supplier, packaging the Item for long term storage, marking it with an expiration date, packaging it with tamper proof packages, etc. In the case of Kosher, Halal, and other process specific products, consumers normally rely on the supervision by specialized inspectors that affix a marking on the product's packaging, and on a distribution network of qualified suppliers.

Over the years, great improvements have been made to protect products used for human consumption. Some of the more relevant advances include a remote communication device that can receive temperature readings from a container and its contents and is able to communicate the readings to an external reader (U.S. Pat. No. 6,847,912).

Another advance consists of the use of a Radio Frequency Identification (“RFID”) tag based system to read and transmit the temperature and global positioning of a transported item to an adjacent RFID tag reader that transmits only the position and temperature at a given moment in time (U.S. Pat. No. 7,221,270).

Yet another advance consists of a method and device for alerting about the consumption of a food item before its usable time has elapsed. The inventive device allows for the registration of the stored item to be monitored, the display of the stored item's name, the measurement of a fixed amount of time, and the issuing of an alert when that fixed amount of time has elapsed (U.S. Pat. Nos. 5,487,276 and 5,711,160).

Another advance consists of a time-temperature measuring device used to determine the time during which the ambient temperature adjacent to the device is above a predetermined temperature, and then display it through a visual calibrated markings of a mechanical contraption used to measure a fluid that flows through an orifice to a nozzle connected a measuring element (U.S. Pat. No. 5,662,419).

Yet another advance consists of a method for tracking the freshness or expiration dates of food products placed in storage. Stored food products are tagged with smart tags containing information regarding the expiration date of the food product. The tagged food products are written into a tag prior to placing the products into storage; then upon reading the tag the user is alerted if the food product's time has expired (U.S. Pat. No. 6,982,640).

However, none of the inventions or existing methods for monitoring the freshness, security, and state of an Item, work as an integrated system. No system provides alerts to take in-route corrective actions or suggests alternative uses when an Item's freshness status has changed, such as, for example and without limitations, when a fresh product is accidentally frozen. While some systems monitor a specific environment parameter, such as temperature, no system integrates the taking of an action to correct a potentially dangerous variation of the monitored Item's parameter with the dynamic adjustment of the effective useful life of the Item. Furthermore, there is no integrated system that provides traceability to an Item's origins, ensuring without human intervention that a customer received the expected Item, and is capable of locating an Item at any point in-route from a supplier or manufacturer to the final customer.

Traditional packaging and preservation methods do not sufficiently address the necessary steps required to ensure that all Items fit for human consumption remain so; nor they provide an integrated system to ascertain that an Item's package was not tampered with or modified in route; or that a change of temperature, humidity, vacuum level, or other environment or transportation parameter, did not alter the expiration date or state of the Item. For example, and without limitation, if a product such as cheese is offered for sale as fresh and in route is accidentally frozen, the freezing will alter the product's molecular structure upon defrosting and a customer will be deceived by a false fresh label. Conversely, when a frozen Item is first defrosted and then re-frozen, the time the Item was defrosted may alter the Item's useful life upon defrosting it again. The final customer usually is not aware of these and other changes occurring during transportation and/or storage and ultimately trusts the misleading date marked on the package or the uninformed indications of a supplier.

Frequently Items are recalled for a variety of reasons, such as contamination, sabotage, tampering, and other external perils. Currently, a production date or code may be marked on an Item or its packaging at the place of production. Usually the marking is applied to large quantities of identical Items, produced or harvested at a particular time, to permit the trace back of a later discovered unfit Item, thus permitting a recall of the batch produced. However, if a limited number of Items, smaller than a production or harvest batch, needs to be recalled or removed from the chain of commerce, currently there is no system that could identify an Item or a component of an Item, while at any point in route, back to its origins, and permit its removal while not recalling other unaffected Items from the same batch. When an Item is recalled, undamaged or unaffected Items are recalled as well, unnecessary transportation expenses are incurred and valuable reputation, insofar as supplier reliability is lost.

### BRIEF SUMMARY OF THE INVENTION

The inventive System ensures that a monitored Item maintains all its predetermined shipping and storing parameters such that its freshness, certification (Kosher, Halal, etc), state (fresh, frozen, raw, pre-cooked, cooked, etc.), and that its physical integrity has not been violated, from manufacturing or harvesting until delivery to a final customer.

The System comprises four major components: at least one environment-tracking device (“ETD”), at least one container control device monitoring unit (“CCDMU”), an CCDMU interface device, and a remote central server (“RCS”). The System components are interconnected by a variety of wired and wireless means and have diverse capabilities as explained hereinafter.

An ETD is a sensor device utilized to measure a pre-determined environment parameter such as, for example and without limitation, temperature, humidity, internal and/or external pressure, vacuum level, air-purity (oxygen, nitrogen, carbon dioxide, and other gases levels), fermenting gas level (such as ethylene), light exposure/brightness, and other environment parameters well known to a person skilled in the art (“environment parameter”). An ETD may also monitor non-environment parameters, such container open/closed status, noise, motion, a heart's rate, blood pressure, and others well known to the person skilled in the art (“non-environment parameters”), that are nevertheless necessary to maintain a transported Item in optimal conditions, such as when live animals are transported.

ETDs are well know to a person skilled in the art and include, without limitations, thermocouples, thermometers, barometers, hygrometers, strain gauges, micro switches, fuses, photovoltaic cells, mercury levels, thermal sensors, microphones, seals, cardiometers, electromagnetic monitors, spectrochromatographers, etc.

An ETD may be wired or wirelessly connected to a CCDMU and may be incorporated into a CCDMU or be external. An ETD may also be connected to an RFID tag or may operate independently from a CCDMU. ETDs may be placed directly on an Item, including on live animals, or on an Item's container.

For a variety of reasons, when an energy source is not available, or may have been depleted while in-route, or a connection with a CCDMU may not be possible, an ETD may also be used to monitor only one environment critical condition, such as whether a container has been open, or whether a predetermined temperature, humidity, vacuum, etc., has exceeded a critical threshold. ETDs, through their native energy source, may effect a change of status and load the new status on an RFID tag, turn on a thermal indicator, or provide a visual display, such that, upon its viewing or reading, it indicates that a critical point was exceeded.

A CCDMU is a device with native capability to collect and analyze an ETD's measurements, to temporarily store and arrange the ETD's collected data, take autonomous intelligent actions to adjust one or more container's environment parameters according to an Item's default profile, and operate a variety of audiovisual status indicators. A CCDMU can communicate with various ETDs, with other CCDMUs, with external CCDMU interface devices, and with the RCS. Each CCDMU is attached to an Item's container, to structures that hold and transport Item containers (such as pallets), and to long distance transportation containers, as they may be used in the various stages and modes of transportation from the farmer-producer-manufacturer to the Item's final customer.

A CCDMU interface device is a device that, through wired, wireless, optical, or thermal connection is capable of accessing a CCDMU's data and exchange information with it. A CCDMU interface device may also have the capability to communicate with the RCS directly or through a communication host. The CCDMU interface device is the interface of the System with a user and is capable of providing detail information, historic data, interpret System alarms, identify a particular Item within a transportation container, provide information about an Item's location, and make intelligent suggestions about a transported Item mutated state.

The RCS has the functions of defining an Item's default profile for each of the environment parameters that must be maintained during transportation and storage and the variations that may be tolerated thereof, enforce the appropriate business rules for each Item, communicate with the various CCDMUs deployed during transportation and storage, issue alerts and suggestions about an Item in peril, monitor and establish at anytime an Item's location, collect, keep, and analyze data for optimizing an Item's default profile, and a variety of administrative tasks.

Communications between the different components, including the ETDs, CCDMUs, and RCS may be accomplished utilizing a variety of wired and wireless means, such as, for example and without limitation, direct connections by well known electro-optical means, or indirect connections via radio frequency, microwaves, internet, acoustic coupling, laser, thermal, infrared, and other means well known to a person skilled in the art.

The System, through its CCDMU, provides one or more audiovisual alerts when a violation of a predetermined and monitored environment parameter occurs. A CCDMU may provide a visual alert by turning on a light on a set of lights, display a written message or graphic sign, or change a flag. The system may also provide an audible alert. The CCDMU issues an alert when no changes have occur in the shipping conditions of an Item, when at least one monitored Item's parameter has exceeded a predetermined value, and when, in spite of corrective actions, there has been spoilage or a severe violation that merits in-route active intervention. Upon recognizing an alert, a user may conduct further inquires with a CCDMU interface device or with the RCS and receive System suggestions.

Furthermore, a CCDMU, through its native artificial intelligence and while connected to the Item's container environment control devices, may dynamically adjust one or more environment parameters to prevent or correct an Item's default profile violation. For example and without limitation, the CCDMU may reduce or increase the container's internal temperature, humidity, oxygen or other gas, create or increase a container's vacuum, issue noise cancellation signals, etc.

The System alerts permit the timely redirection to an alternative destination of a container, or a part thereof, when at least one Item is determined to be non-compliant with the default profile or it is spoiled; additionally, the System also suggests alternative uses for the non-compliant Item. If an Item is salvageable, then the system dynamically modifies its lifespan and denotes the change, such that an alternate customer could be served to whom the mutated product may be useful, thus saving hopeless transportation costs of an unwanted and unfit product.

### DRAWINGS

FIG. 1a is an embodiment of an environment-tracking device (“ETD”).

FIG. 1b is an embodiment of an environment-tracking device (“ETD”) with wireless communications capabilities.

FIG. 2 is an embodiment of a container control device monitoring unit (“CCDMU”).

FIG. 3a is an embodiment of an Item container with its CCDMU and corresponding ETDs.

FIG. 3b is an embodiment of an Item container for a live animal with its CCDMU and corresponding ETDs.

FIG. 4 is an embodiment of a palletized Item container with its CCDMU and corresponding ETDs.

FIG. 5 is an embodiment of a controllable-environment transportation container, with its CCDMU arid corresponding ETDs, and nested palletized Item containers with their CCDMU.

FIG. 6 is chart of the remote central server (“RCS”) and its relationship to CCDMUs and ETDs.

FIG. 7 is an embodiment of the System depicted through a schematic representation.

FIG. 8a is an embodiment of a CCDMU interface device for an Item Container.

FIG. 8b is an embodiment of a CCDMU interface device for a palletized Item container.

FIG. 8c is an embodiment of a CCDMU interface device for a transportation Container.

### DETAIL DESCRIPTION OF THE INVENTION

In a preferred embodiment of the invention, FIG. 1a depicts an embodiment of an ETD 101 comprising a sensor 102 for measuring an environment variable such as, for example and without limitation, temperature, humidity, barometric pressure, air purity (oxygen, nitrogen, etc.), fermentation gases (ethylene and other gases), load strain, vacuum, light exposure/brightness, noise, and other parameters well known to a person skilled in the art. The sensor 102 is connected to a sensor interface 103 that processes the input of sensor 102 and digitizes it, and manages the ETD communication functions. The sensor interface 103 is connected to a communications port 104 that permits wired communications. Energy to power the ETD components may be supplied through a wired communications port 104 or through an embedded self-generating power supply 108 connected to the sensor interface 103.

FIG. 1b depicts a stand-alone ETD 105 that has the basic functionality as the previous ETD embodiment 101, except that its sensor interface 106 manages wireless communications through a wireless transmitter/receiver port 107.

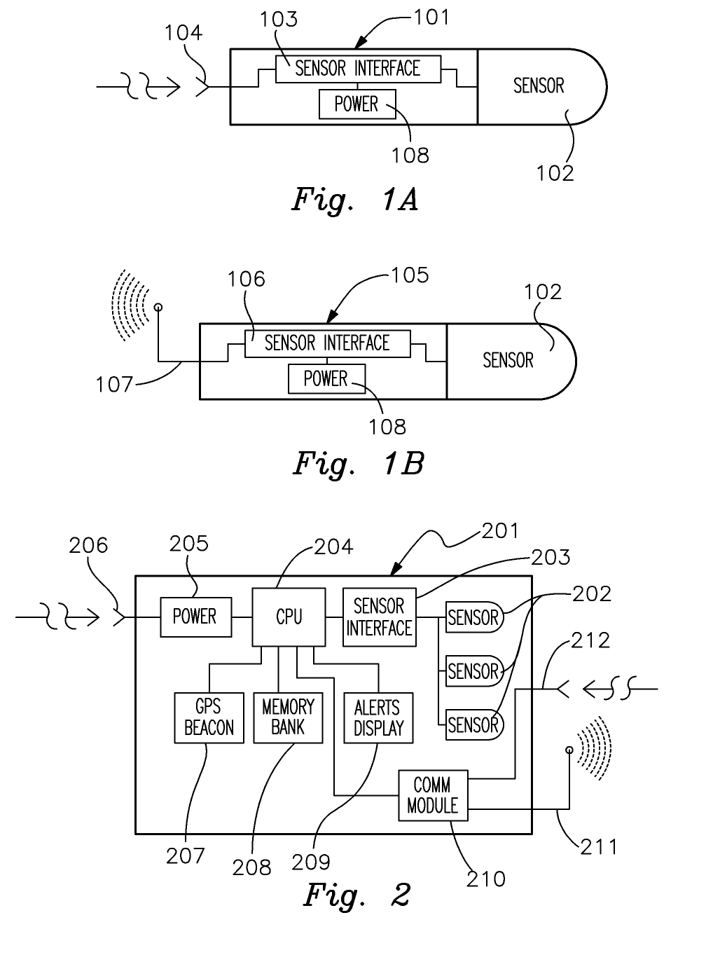

FIG. 2 depicts a possible embodiment of a CCDMU 201 comprising one or more embedded environment sensors 202, performing similar environment measurement functions as ETD's sensors 102. A sensor interface 203 is connected to the embedded sensors 202 to process and digitize their measurements. The sensor interface 203 communicates the digitized sensors' 202 measurements to a central processing unit (“CPU”) 204 that has various capabilities such as, for example and without limitations, organize the sensors' 202 inputs, manage a native memory data bank 208, operate a communication interface module 210 to communicate with other CCDMUs, CCDMU interface devices (not shown), and the RCS (not shown), run a global positioning system beacon 207, operate an alerts display module 209, and execute other administrative tasks well know to a person skilled in the art.

The communication interface module 210 is capable of wired communications through a wired port 212, such as, for example and without limitation, RS-232, parallel connection, USB, and others well know to a person skilled in the art. The communication interface module 210 also manages the wireless communications capabilities of the CCDMU 201, such as, for example and without limitation, Radio Frequency, Infrared, Bluetooth, satellite bands, and others well know to a person skilled in he art, through a wireless port 211.

An embedded self-generating power supply 205 supplies the CCDMU 201 with its energy requirements, alternative power sources, such as direct connection to an external source 206 may be used.

The alerts display module 209 displays by a variety of audiovisual means, such as, for example and without limitations, a set of colored lights, a multilingual text display, a set of colored flags, an audible alarm, and other audiovisual means well known to a person skilled in the art. In a preferred embodiment, a set of three lights, colored green, yellow, and red, provides alerts when any Item within a transportation container is within the default parameters (green light), has violated a default parameter and requires external attention (yellow light), or at least one Item is spoiled and needs to be removed, rerouted, or destroyed (red light).

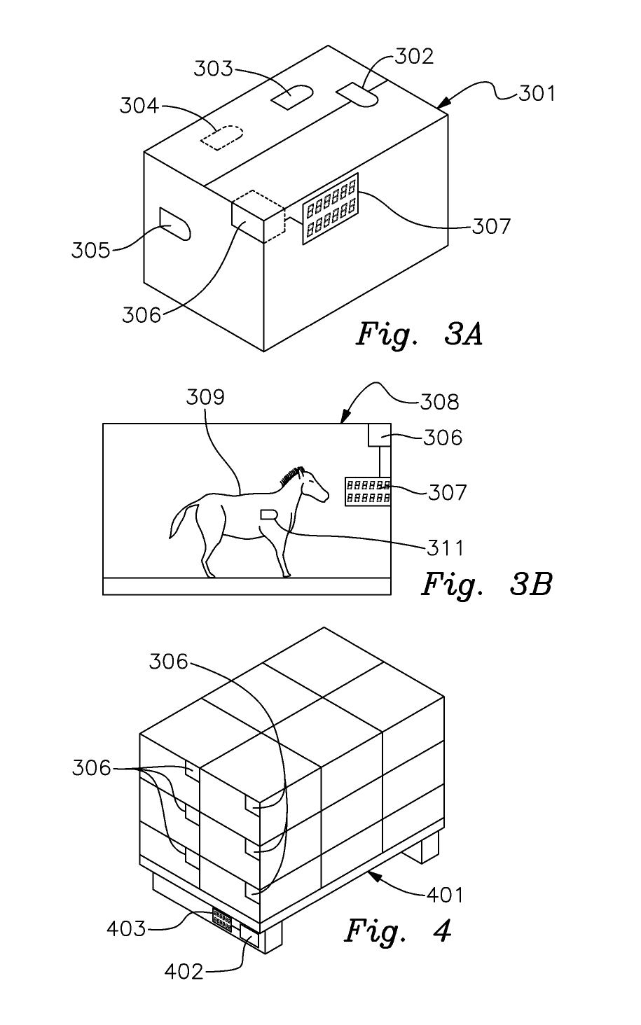

FIG. 3a depicts an Item container 301, which may be reusable or not. The Item container 301 is equipped with a Item CCDMU 306, which has embedded at least one ETD and is connected by wired or wireless means to an Item container anti-tampering sensor 302. The Item CCDMU 306 may also be connected to a plurality of internal ETDs 304 and external ETDs 305 to measure a plethora of previously discussed environment parameters. The Item CCDMU 306 may also monitor special function ETDs, such as a strain gauge 303, utilized to determine whether the load of other containers placed on top an Item container has deformed or crashed it. The Item CCDMU 306 provides alerts about the condition of the transported Item through its native alert display 209 or through an external alert display 307.

FIG. 3b depicts a special transportation situation, as when it is necessary to contain an Item within a special container 308, such as when transporting live animals 309 or commodity grains (not shown). In these cases, a transportation container 308 shall be equipped with a CCDMU 310 and with special functions, non-environment ETDs, such as an animal's heart monitor 311, a container's oxygen sensors, an animal's blood pressure, and other non-environment parameter ETDs, well known to a person skilled in the art.

FIG. 4 depicts a palletized Item container 401 equipped with a CCDMU 402 capable of communicating with each individual Item container CCDMU 306. The pallet CCDMU 402 monitors its palletized item containers and provides alerts about their condition through its native alert display 209 or through an external alert display 403.

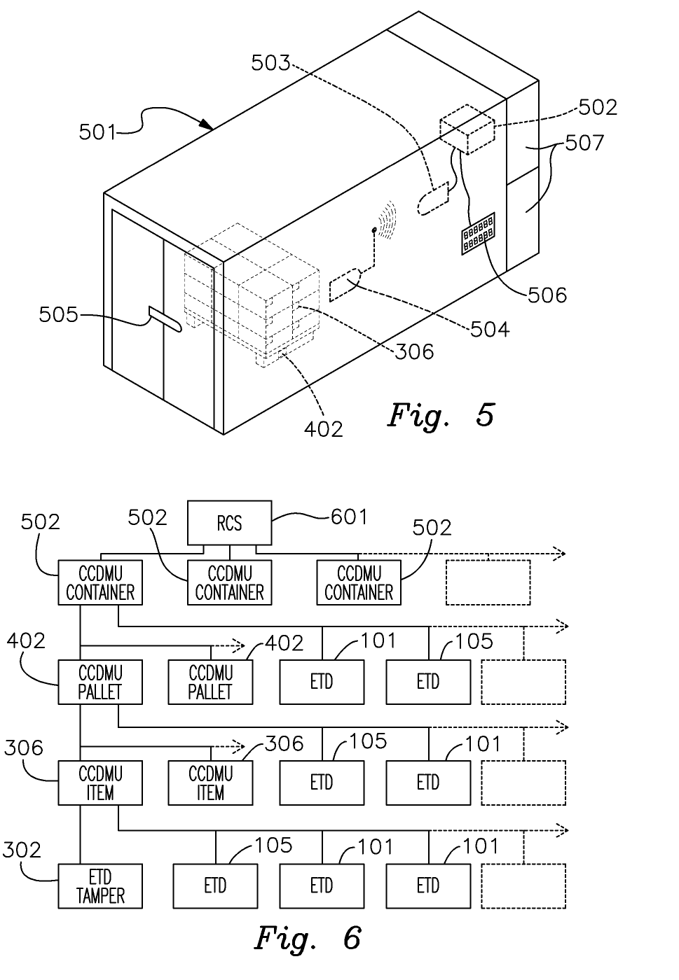

FIG. 5 depicts an enclosed transportation container 501 with native capabilities to control its internal environment 507, such as, for example and without limitations, modify its temperature, humidity, pressure, vacuum, gas contents, noise, and other environment parameters well known to a person skilled in the art. The transportation container 501 is equipped with a transportation container CCDMU 502, capable of communicating with a nested pallet container's CCDMU 402 or, if shipped individually, with a nested Item container's CCDMU 306, and with the RCS, not shown. The transportation container's CCDMU 502 is communicatively connected directly to a variety of ETDs 503, and/or wirelessly connected to a variety of external ETDs 504 disposed throughout the transportation container 501. The transportation container's CCDMU 502 is also connected to a transportation container's anti-tampering sensor 505 that immediately alerts the RCS, the CCDMU interface device, both not shown, and a direct observer in case of break-in. The transportation container CCDMU 502 provides alerts about the condition of the container through its native alert display 209 or through an external alert display 506. The container CCDMU 502 also operates a global positioning system beacon, not shown, that it is monitored at all times by the RCS, not shown.

FIG. 6 depicts a schematic drawing of the System whereby an RCS 601 has overall control of the system and communicates with all deployed container CCDMUs 502. The RCS 601, contains the default business rules and environment parameters to be monitored for each transported Item. The RCS 601 is able to instruct the corresponding container CCDMU 502, pallet container 402, or Item container CCDMU 306, what are the rules and parameters to be maintained and measured. In most cases, Items will be shipped through an Item Container 306, but there may be times, such as when transporting live animals or loose commodities, such as unpackaged grain, that a container CCDMU 502 will communicate directly with an external ETD 101 or 102 and rely its findings to the RCS 601.

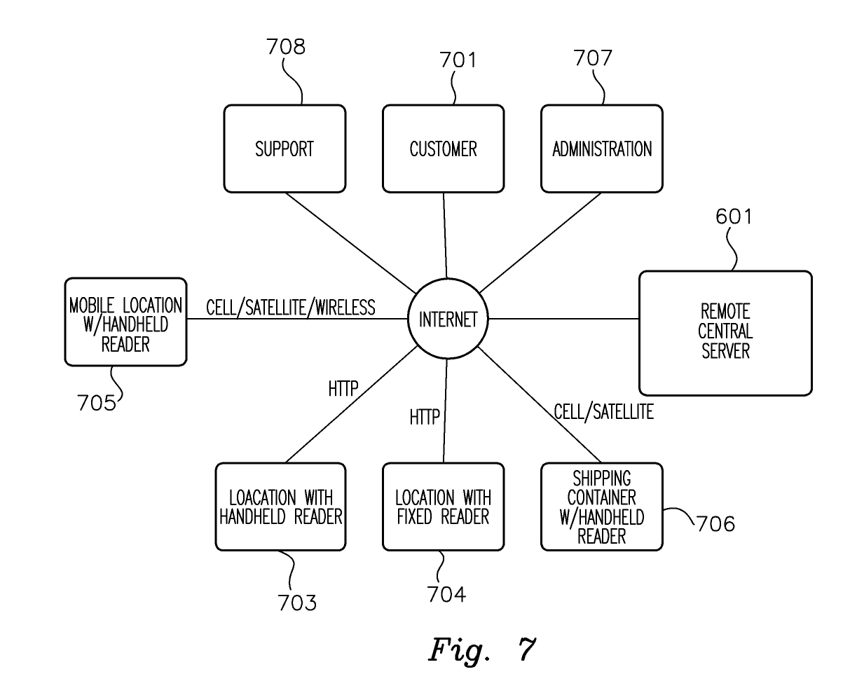

FIG. 7 depicts the System and its interaction with its customers 701. A customer 701 accesses the RCS 601 through an on-line or direct connection and specifies descriptive and other administrative parameters regarding the Item to be transported or stored. Should questions arise any anytime, that may not be resolved by on-line information, customer service representatives 708 and administration personnel 707 could intervene on the customer's behalf.

A customer accesses the container Item's CCDMUs 306 utilizing a handheld CCDMU interface device 703, or a fixed CCDMU interface device 704. If there is a need to access a container Item while in-route, a customer 701 may use a mobile location CCDMU interface device 705 or access the container CCDMU 502 directly.

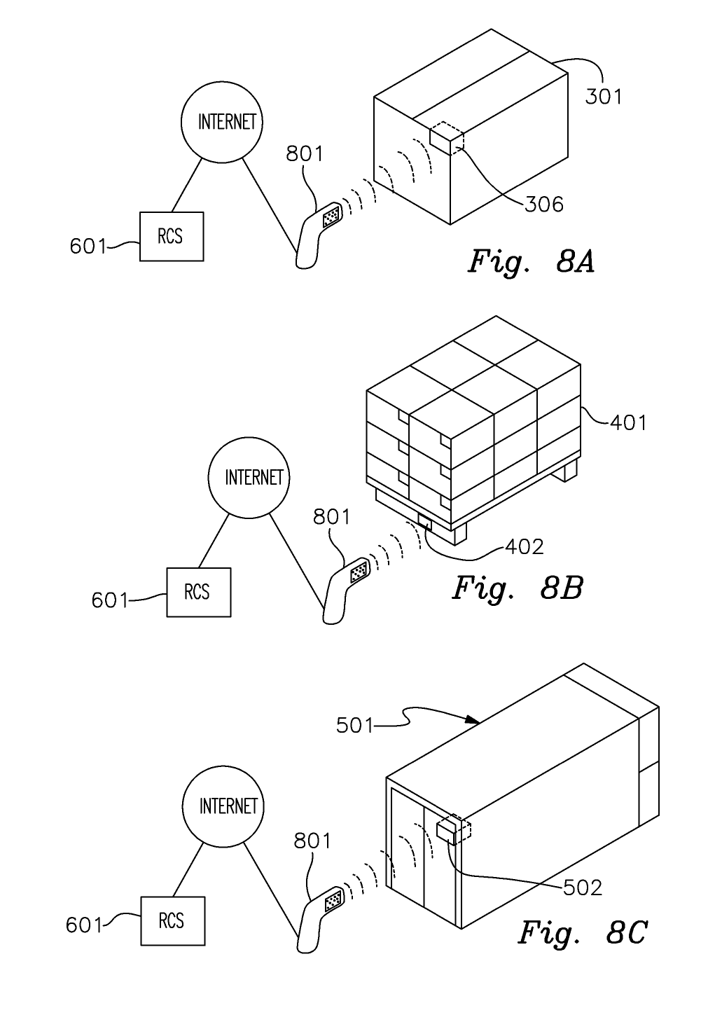

FIG. 8a depicts one embodiment of a handheld CCDMU interface device 801 exchanging data with an Item container's CCDMU 306 and with the RCS 601. FIG. 8b depicts another embodiment of a handheld CCDMU interface device 801 exchanging data with an palletized Item container's CCDMU 402 with the RCS 601. FIG. 8c depicts yet another embodiment of a handheld CCDMU interface device 801 exchanging data with a transportation container's CCDMU 502 and with the RCS 601. An CCDMU device may be handheld 801, affixed to another mobile structure 706 or fixed to a particular location 704.

System Operation

A CCDMU 306, 402, or 502, periodically collects through its associated ETDs predetermined environment data and stores the selected measurements in its native memory 205. At certain checkpoints, which are defined by a business process and/or compliance requirement, a container CCDMU 502 may transmit its collected data to the RCS 601. Alternatively, a CCDMU interface device 703, 704, 705, or 801 is placed in proximity of said CCDMU to retrieve its collected data and to analyze it and/or transmit it by a variety of communications means to the RCS 601. The CCDMU 306, 402, or 502, stores preprogrammed business rules applicable to the specific monitored Item and it is capable of analyzing the received ETD's data and making an autonomous intelligent decision, and, if necessary, follow it up with a corrective action and/or instructions. Furthermore, when applicable, the CCDMU data is transmitted to the RSC 601 where a higher-level decision may be made based on wider set parameters of defined business logic and collected data.

### Features of the System

### Product Composition Threshold

In certain situations, defined in the Item's business rules, when a measured environmental parameter was outside a predetermined range for a short period of time, the System will record a violation, and it may or it may not take any corrective action. However, when repeated violations accumulate over time, whether or not a corrective action was taken, the System may determine the Item to be spoiled, or mutated.

When a multiplicity of Items are used to prepare or create a new final product, and one or more Items comprising the final product may have accumulated too many individual violations, the System, according to the business rules, may determine that the final product may be considered spoiled, even if each individual component may not have reached the determination of spoiled.

The System, through its historic data memory permits to trace back a final product's Item components to the original components utilized to conform it.

### Contamination and Tampering Identification and Tracing

When at least one Item in a final product is found to be contaminated, even if the contamination may not be discovered until a final product is assembled, or manufactured, once it is discovered the System permits its trace back to the origin of any of the Items used. The System simultaneously marks all other final products, utilizing the same contaminated Item, as spoiled and enables the triggering of an intelligent and limited final product recall according to the predefined business rules.

The System's CCDMUs 306 or 502, also monitor against tampering, sabotage, and unauthorized access to an Item in-route. An ETD anti-tampering sensor 302 is placed on the Item's container 301 and on the transportation container 505, and notifies its corresponding CCDMU 306 or 502, when a container undergoes a non-authorized opening. In such an event, the CCDMU 306 or 502 will issue a container open alert. A separate strain gauge ETD 303 may be placed on palletized containers to notify about an Item container 301 overload, crashing, and/or spontaneous opening.

### Transportation Lifespan Monitoring

A CCDMU 306, 402 or 505, constantly collects environment information about an Item, from the moment the Item is stored in a CCDMU enabled container 306, throughout its monitored life, and until it is delivered to a final customer 701. A CCDMU 306 or 502, may store only those events that are deviations from a predetermined range. Furthermore, a CCDMU 502 may download and synchronize its collected data at certain predetermined checkpoints with the RCS 601, when it can make a decision about the state of the freshness of an Item. This continuous measurement and synchronization method provides for no gaps in an Item's environment monitoring conditions during its transportation and storage lifespan.

### Dynamic Environment Profile Monitoring

Each Item has a corresponding predefined default profile for all its environment monitored parameters (temperature, humidity, vacuum, oxygen, light exposure, etc.) that must be maintained from its origin, throughout its storage, and until it is delivered to a final customer 701. However, when a container CCDMU 502 registers a violation of one or more predefined environmental parameter, the system will first determine if it can take a corrective action, such as modifying the temperature, humidity, vacuum, gas level, barometric pressure, etc., and, if such corrective action is possible, then it will adjust the lifespan for the Item.

For example, if a container of fresh meat was exposed to a temperature higher than the predetermine default profile permits, but it did not reach the point of declaring it spoiled, then returning the pallet to the default profile temperature conditions may not be sufficient to compensate for the violation of the temperature overheating. Under those conditions the freshness' tracking and monitoring system will record the violation and may either suggest or command the use of a substantially lower temperature, including freezing, and then adjust the Item's lifespan accordingly. In the preceding case, the meat's adjusted lifespan may be shortened, marked to be consumed immediately upon defrost, mandate its cooking and consumption upon defrost, process immediately upon defrost, utilize for an alternative use, such as animal feed, upon defrost, or declared spoiled and mandate its destruction. Similarly, if a pallet of fresh meat was accidentally frozen instead of just refrigerated, then the freshness tracking and monitoring system may record the freeze, change the status from fresh to frozen, and prolong the lifespan accordingly. In the same example, if the meat remains frozen for too long, then the system will adjust the lifespan accordingly and may declare it spoiled, or determined a suitable use, if any, upon defrost.

In another example, if a product that needs to be preserved under vacuum conditions and it looses its vacuum, the System may not be able to restore vacuum to the single container Item 301, but may create a vacuum in the transportation container 501. Alternatively, the System may, if the default Item permits, lower the temperature to a freezing point and then annotate the mutation.

### Item Identity

Every CCDMU 306, 402, or 502, shall have a unique identifier. This unique identifier will enable to pinpoint and track a container within a given group of containers.

To enable the tracking of a significant number of Items within the same container, aggregated identification is used. Specifically, when several Items, whether different or conforming to a different default profile, are grouped into a single pallet or container, then additional identifiers are used. Furthermore, when a group of container Items 301 are nested within a larger transportation or storage container 501, the larger container's CCDMU 502 will be associated with the smaller container's CCDMUs 402 and 306, nested within for the duration they are physically present inside the large container 501 or storage warehouse. Thus, the large container CCDMU 502 may collect information from any nested container CCDMU 402 and 306, and its associated ETDs, allowing the acquisition of the environment's information for all items currently associated with this container. Keeping this container association allows for the reduction of data synchronization steps without the loss of item-level precision in the environment information.

In a preferred embodiment, a string composed of a fixed unique identifier section and a changeable variable-length identifier section represents the CCDMU identity. The unique identifier permits the recognition of a CCDMU 306, 402 or 502, amongst others within the System. The changeable variable-length identifier allow for the reading of a plethora of variable markers including, but not limited to, the description of an Item, an alternative description of the Item, which protects the Item identity but it is matched to the true identity at the RCS's 601 level, environment parameter violations, and particular transportation requirements, which remain constant during at least one leg of the transport or storage.

### Alternative Identity

Every Item may be designated with an alternative unique identifier. An alternative unique identifier is an System-generated globally-unique identifier that is assigned to an Item in the System for the purpose of disguising the Item. An alternative unique identifier may contain alphanumeric or graphic markers to distinguish it with particularity such that a supplier of an Item may be capable of distinguishing one batch or harvest from another.

### Association and Dissociation

The System manages the association of Items to the CCDMUs of different Items 306, pallets 402, containers 502, etc., their interrelationship, and the association of the CCDMUs to their corresponding ETDS. A standalone ETDs 105 may also record information about the container it is currently associated. The System manages the aggregation and nesting of entities for more efficient tracking. It is important to note that the Item-container association is based on time, thus, the same container can be associated to different Items at different times. The RCS 601 keeps track of all associations and correctly identifies and resolves any Item-container association issue.

### Channeling

Having an Item-container association allows the possibility of real-time decision making by channeling containers with non-compliant Items to exception handling paths. For example, a CCDMU interface device 702, 703, 704, or 705, may scan a CCDMU 502 to find out that a transportation container 501 that has been exposed to high temperature for five hours.

A particular container may hold a variety of Items and some may not be affected by the high temperature. The System distinguishes those pallets 401 within the container 501 that may not have been affected by the high temperature from those that were placed in peril and require one or more corrective actions, such as immediate freezing or consumption, and those that may have spoiled as a consequence of the high temperature exposure.

### Alternative Data Acquisition

The System is capable of exchanging data and manage a multiplicity of sources of input, well known to a person skilled in the art, including but not limited to barcode scanning, RFID scanning, graphic scanning, and optical capture.

### Intelli Sense

Artificial intelligence sensor measurement algorithms are utilized to increase the accuracy and performance of ETDs; the following features are used:

### Interpolation

The System allows for the collection of multiple readings from several ETDs placed in the same container. Analyzing and processing those readings allows the calculation of maximum, minimum, and average measurements, as well as to interpolate the environment conditions in different areas of the container that have no ETDs. For example, having multiple ETDs will allow a more precise calculation of temperature inside a container that was exposed to direct sunlight on one of its sides. The side of the container exposed to the sunlight will register a higher temperature than the not exposed side, thus reading only one ETD will provide inaccurate measurements for the entire contents of the container.

### Task Separation

The System is capable of utilizing a multiplicity of ETDs to monitor different alerting conditions of a same Item. For example, an Item may be monitored by two ETDs, one that monitors and records temperature fluctuation and another that records only critical overheating. Should a monitoring ETD fail, a second ETD monitoring a critical condition may still operate and warn if the critical situation was reached.

There may be several ETDs monitoring different factors and conditions within the same container such as temperature, humidity, pressure, location, noise, light, oxygen, and other factors well known to the person skilled in the art. The System may collect data from different CCDMUs 306 and 402 to compensate for a failed ETD reading.

### Chaining & Redundancy

CCDMUs 306, 402, and 502, are linked together in a chain such that upon a CCDMU's warning of filled storage capacity, depleted energy, or malfunctioning circuitry, a predetermined portion of that CCDMU's collected data, such as critical points surpassed and other warnings, is transmitted to another CCDMU up the linked chain. For example, and without limitations, if a container Item CCDMU 306 fails, then critical points are monitored by the pallet CCDMU 402 or the transportation container CCDMU 502. This chaining allows for scalability, redundancy, and reliability.

### Business Logic Rules

The System can analyze and identify conditions matched to customized rules, which are defined by the business domain processes. Several of the business logic rules are defined below:

### Friend/Foe

This rule alerts when two or more products that must be shipped together are not together, and thus the short shipment is unusable by the final customer. Conversely, the rule alerts when two incompatible items, such as food and poison, get too close to each other.

### Minimum/Maximum Quantity Rule

This rule alerts when the number of items is less than the specified minimum number of items acceptable to a customer, therefore the order is incomplete and unusable by the customer. This rule allow for the return or redirection of a short order. Conversely, the rule alerts when the number of items is more than the specified maximum number of Items acceptable to a customer.

### Minimum/Maximum Common Environment Parameter

This rule alerts when a specific environment parameter, such as temperature, humidity, oxygen, carbon dioxide, ethylene, vacuum, etc, is lower or higher than the specified minimum or maximum value.

### Corrective Actions and Instructions

When the container CCDMU 502 registers a violation of a parameter of the default profile, if the container has the capabilities, the CCDMU 502 may take the following corrective actions and issue the following instructions:
1. Maintain temperature; then adjust Item's life.
2. Lower/raise Temperature; then adjust Item's life.
3. Freeze Item; then shorten/lengthen Item's life.
4. Freeze Item, then upon defrost consume immediately.
5. Freeze Item, then upon defrost, cook, and consume immediately.
6. Freeze Item; then upon defrost incorporate.
7. Freeze Item; then upon defrost use for other than human consumption.
8. Increase/decrease fermentation gas; then adjust Item's life.
9. Increase/decrease humidity; then adjust Item's life.
10. Destroy and dispose Item.

### Process Flow

### Identification

Every CCDMU 306, 402, and 502, in the System shall have a unique identifier. In case a CCDMU does not have an identifier or it is not accessible, the RCS 601 will generate and assign a temporary identifier and stored it inside the CCDMU's erasable programmable memory. This event may happen if a CCDMU is non-complaint or compatible with the system, yet it is capable of performing the tasks assigned, has native capacity to store and manage data, and otherwise can perform the system's assigned tasks.

### Association

Each Item will be associated with its corresponding container CCDMU 306. This association shall be direct, but may be indirect via an intermediary entity, for example, a transportation container CCDMU 502. A typical scenario may be: An Item is associated with a shippable container 301, and the shippable container 301 in turn is associated with a CCDMU 306. The shippable container 301 may be a reusable container, in such a case the association will be a temporary association and the System will record and manage the start and end time of such association.

### Initialization

During the association, the CCDMU 306 will be assigned a default profile for the associated Item. The default profile specifies the environment's parameters that are required to be monitored and recorded during the term of the association.

Since a CCDMU 306 may have a limited data storage capacity, the default profile also contains the critical points for all monitored parameters, as well as rules for each range. For example, and without limitations, depending of the nature of a specific Item, a frozen Item having temperature behavior similar to water may have a “frozen” range (from −40° to −1° C.), a “thaw” range (from +0° to +5° C.), a “warm” range (from +6° to +15° C.), and a “hot” range (from 16° C. and over). Depending on its type (meat, produce, and dairy, etc.), every product will have different default profiles with appropriate ranges. Thus, for example, if the Item is frozen meat, then when it is at −5° C. or below it is in the “frozen” range, and thus it is considered in a satisfactory state. In such case, the CCDMU 306 will record the temperature values rarely, for instance every hour. In case the meat reaches a temperature of 3° C., then it is considered in the “thawed” range, and thus, the temperature will be captured every 10 minutes. At that point, the CCDMU 306 will issue an alert and will propagate the information up the chain of nested CCDMUs up to the RCS 601. The CCDMU 502 may effect a corrective action, such as lower the temperature of the container. However, when the same container includes products that should not be frozen, such as milk, the CCDMU 502 may lower the temperature to the minimum possible, then it will issue instructions to use immediately or to discard, according to a relevant business rule. In case that meat reaches a temperature of 25° C. (77° F.) for an unacceptable length of time, then the system will mark the Item as unusable and order its destruction or another appropriate alternative use.

### Data Collection

ETDs collect data from their environment and transmit it to a related CCDMU 306 or 502. The CCDMU, through its native capabilities, analyzes the data for compliance with its associated business rules and default profile. Amongst other activities, the CCDMU may record a collected parameter value, compare it with its default value, disregard a collected parameter value, update an Item's profile parameter, and/or adjust an item lifespan, etc.

### Data Synchronization

At random or predetermined milestones, depending on the Item's applicable business rules and communications capabilities, a nested CCDMU 306 will synchronize its collected data to with the pallet's 402 or transportation container's 502 CCDMUs, and in turn the container CCDMU 502 will synchronize its data with the RCS 601. This data exchange communication session can take place through a variety of different means, such as wired or wireless connections means well known to a person skilled in the art.

### Analysis and Processing

A CCDMU's native processing capabilities can perform calculations and analysis of the collected data and act upon a predefined set of business rules. Among other resources a CCDMU has access to the Item's historical data and default profile, and may have information about the expected conditions of the foreseeable future associated with the Item, such for example and without limitations, weather forecasts, length of travel, traveling route, container transferring points, scheduled in-route container inspections, etc.

Data collected from various nested CCDMUs allows a container CCDMU 502 to perform a more educated decision on the status of an associated Item. It can also update and re-define the default profile for the associated item. If needed, a CCDMU can query other CCDMUs in order to acquire additional information or request a higher-level device to analyze and process the data and generate a decision (escalation).

### Feedback Synchronization

A decision from the RCS 601, or a container CCDMU 502, will be communicated to the container Item's CCDMU 306. This decision may be communicated directly or relayed via one or more CCDMUs. The decision may include an updated Item default profile for improved product status monitoring, which will be used instead of the default profile for future monitoring or instructions to handle the Item at the first available opportunity.

1. A freshness tracking and monitoring system, the system comprising:
at least one remote central server hosting a central database and a plurality of user interface administrative tools, with native processing, data storage, global positioning beacon tracking, and communications capabilities, and communicatively connected with;
at least one container control device monitoring unit designated with a unique identifier and with native data processing, data storage, global positioning beacon, and communications capabilities, communicatively connected with;
at least one environment tracking device;
at least one container anti-tampering sensor; and
at least one container control device monitoring unit interface device.

2. The at least one container control device monitoring unit of claim 1, wherein the monitoring unit is powered by a self-generating power supply or an external power supply.

3. The at least one container control device monitoring unit of claim 1, wherein the monitoring unit has at least one coupled audiovisual alert device capable of displaying at least one audiovisual alert selected from a group consisting of an audible sound, an audible spoken message, a text message, a graphic message, at least one illuminable light, a light semaphore, and a mechanical semaphore.

4. The at least one coupled audiovisual alert device of claim 3, wherein the alert device is communicatively connected to the at least one container control device monitoring unit through a direct electro-optical connection or through a wireless connection.

5. The at least one container control device monitoring unit of claim 1, wherein the monitoring unit collects and manages the input from at least one environment tracking device to which it is communicatively connected through a direct electro-optical connection or through a wireless connection.

6. The at least one environment tracking device of claim 1, wherein the device has a self-generating power supply sufficiently large to satisfy the energy requirements of the device, a sensor capable of measuring a plurality of environment and non-environment parameters, and sensor interface capable of processing the sensor's analog or digital measurements and connect through wired or wireless communications capabilities with the at least one container control device monitoring unit.

7. The at least one environment tracking device of claim 6, wherein the self-generating power supply is electrically supplied through an external power supply.

8. The at least one environment tracking device of claim 1, wherein the device is capable of measuring at least one environment parameter selected from a group of parameters consisting of temperature, humidity, barometric pressure, vacuum, oxygen, carbon dioxide, nitrogen, air purity, air contamination, fermentation gases, ethylene, noise, and light.

9. The at least one environment tracking device of claim 1, wherein the device is capable of measuring at least one non-environment parameter selected from a group consisting of container load strain, animal's heart rate, animal's body temperature, and animal's blood pressure.

10. The at least one container anti-tampering sensor of claim 1, wherein the sensor has a self-generating power supply, is capable of monitoring a container's access port, has native capabilities to record, authorize or deny access to the container's access ports, and to communicate an unauthorized container's access to at least one container control device monitoring unit.

11. The at least one anti-tampering sensor of claim 1, wherein an unauthorized container access results in an observable mark in the anti-tampering sensor.

12. The at least one container control device monitoring unit of claim 1, wherein one monitoring unit is intrinsically coupled with one container.

13. The one container of claim 12, wherein one container is nested within at least another container and they are communicatively connected between each other.

14. The at least one container control device monitoring unit interface device of claim 1, wherein the interface device has native capabilities for data processing and storage, user interface, audiovisual display, and a plurality of direct and wireless communications means with the at least one remote central server and with the at least one container control device monitoring unit.

15. The at least one container control device monitoring unit of claim 1, wherein the monitoring unit's data storage capabilities are sufficiently large to store an aggregate quantity of data to back-up a non-responsive nested container's monitoring unit.

16. The at least one remote central server of claim 1, wherein its communications capabilities includes at least one selected from a group consisting of plain old telephone system, cellular, G3, GPRS, WiMax, Internet, microwave, and satellite.

17. The at least one container control device monitoring unit interface device of claim 1, wherein the interface device is mobile or is attached to a fixed location.

18. The container control device monitoring unit interface device of claim 1, wherein the interface device communicates with the container control device monitoring unit when it is placed in proximity of it.

19. A freshness tracking and monitoring method, the method comprising:
accessing a central database resident in a remote central server;
inquiring with the remote central server if an item is registered in its central database, if so, retrieving the item's default profile, if not, registering the item with the remote central server and configuring its default profile;
placing the item into a container control device monitoring unit equipped container;
entering the item's default profile into a container control device monitoring unit;
activating an anti-tampering environment tracking sensor of the container control device monitoring unit equipped container;
transporting or storing the container control device monitoring unit equipped container;
monitoring and denoting environment deviations from the item's default profile;
adjusting and denoting the item's lifespan changes in reference to reported deviations from the item's default profile;
monitoring and denoting violations of the anti-tampering environment tracking sensor, and;
opening the container control device monitoring unit equipped container, retrieving the contained item, and resetting the container control device monitoring unit.

20. The freshness tracking and monitoring method of claim 19, wherein the accessing the central database resident in a remote central server is accomplished through a communications coupled container control device monitoring unit interface device or a remote central server terminal.

21. The freshness tracking and monitoring method of claim 19, wherein the item's default profile consist of at least one item-specific transportation or storing environment parameter selected from a group consisting of temperature, humidity, barometric pressure, vacuum, oxygen, carbon dioxide, nitrogen, air purity, air contamination, fermentation gases, ethylene, noise, and light.

22. The freshness tracking and monitoring method of claim 19, wherein the item is a living, non-human, animal and its default profile further includes at least one non-environment parameter selected from a group consisting of container load strain, animal's heart rate, animal's body temperature, and animal's blood pressure.

23. The freshness tracking and monitoring method of claim 19, wherein the entering of the item's default profile into a container control device monitoring unit includes entering information that enables the trace back of the item's harvesting, incorporating, or manufacturing batch parameters.

24. The freshness tracking and monitoring method of claim 19, wherein the placing of the item into a container control device monitoring unit equipped container activates a time measuring device, a global positioning beacon, a transportation container's environment controls, an anti-tampering sensor, and at least one environment tracking device selected from a group consisting of temperature, humidity, barometric pressure, vacuum, oxygen, carbon dioxide, nitrogen, air purity, air contamination, fermentation gases, ethylene, noise, and light.

25. The activated global positioning beacon of claim 24, wherein the beacon permits the remote control server to globally track the position of a container control device monitoring unit equipped transportation container.

26. The freshness tracking and monitoring method of claim 19, wherein the adjusting the item's lifespan changes in accordance with a modified default profile from the item's default profile and extents or shortens the useful life of an item.

27. The shortening the useful life of an item of claim 26, wherein the item is denoted with an item classification from a group consisting of reduced useful life, mutated state, transform and consume, transform and integrate, not fit for human consumption, and unusable.

28. The freshness tracking and monitoring method of claim 19, wherein the registering the item to configure its default profile involves assigning an alternative identity and masking the item's true identity for others than the item's owner.

29. The freshness tracking and monitoring method of claim 19, wherein the adjusting and denoting the item's lifespan changes in reference to reported deviations from the item's default profile corresponds to at least one business logic rule selected from a group consisting of friend/foe, minimum/maximum quantity rule, and minimum/maximum common environment parameter.

30. The freshness tracking and monitoring method of claim 19, wherein the denoting is registered with the container control device monitoring unit, the remote central server, a container control device monitoring unit interface device, and with at least one container control device monitoring unit coupled audiovisual alert device.

31. A freshness tracking, monitoring, and lifespan adjusting method, the method comprising:
accessing a remote database resident in a remote central server;
inquiring with a remote central server if an item is registered in its central database, if so, retrieving the item's default profile, if not, registering the item and configuring its default profile;
placing the item into a container control device monitoring unit equipped environment-controllable transportation container;
entering the item's default profile into the container control device monitoring unit;
activating an anti-tampering environment tracking sensor on the container control device monitoring unit equipped environment-controllable transportation container;
transporting or storing the a container control device monitoring unit equipped environment-controllable transportation container;
monitoring environment deviations of the environment-controllable transportation container from the item's default profile and reporting said deviations through a plurality of reporting means;
adjusting at least one environment parameter of the environment-controllable transportation container in response to said environment parameter's deviation from the item's default profile;
changing the item's default profile lifespan to a different length in response to a reported deviation from the item's default profile and reporting said change of lifespan length through a plurality of reporting means;
monitoring the anti-tampering environment tracking sensor on the container control device monitoring unit equipped environment-controllable transportation container for access violations and reporting said violations through a plurality of reporting means; and,
opening the container control device monitoring unit equipped environment-controllable transportation container, retrieving the contained item, and resetting the container control device monitoring unit.

32. The freshness tracking, monitoring, and lifespan adjusting method of claim 31, wherein the accessing the central database resident in a remote central server is accomplished through a communications coupled container control device monitoring unit interface device or a remote central server terminal.

33. The freshness tracking, monitoring, and lifespan adjusting method of claim 31, wherein the item's default profile consist of at least one item-specific transportation or storing environment parameter selected from a group consisting of temperature, humidity, barometric pressure, vacuum, oxygen, carbon dioxide, nitrogen, air purity, air contamination, fermentation gases, ethylene, noise, and light.

34. The freshness tracking, monitoring, and lifespan adjusting method of claim 31, wherein the item is a living, non-human, animal and its default profile further includes at least one non-environment parameter selected from a group consisting of container load strain, animal's heart rate, animal's body temperature, and animal's blood pressure.

35. The freshness tracking, monitoring, and lifespan adjusting method of claim 31, wherein the entering of the item's default profile into a container control device monitoring unit includes entering information that enables the trace back of the item's harvesting, incorporating, or manufacturing batch parameters.

36. The freshness tracking, monitoring, and lifespan adjusting method of claim 31, wherein the placing of the item into a container control device monitoring unit equipped transportation container activates a time measuring device, a global positioning beacon, a transportation container's environment controls, an anti-tampering sensor, and at least one environment tracking device selected from a group consisting of temperature, humidity, barometric pressure, vacuum, oxygen, carbon dioxide, nitrogen, air purity, air contamination, fermentation gases, ethylene, noise, and light.

37. The activated global positioning beacon of claim 36, wherein the beacon permits the remote control server to globally track the position of a container control device monitoring unit equipped transportation container.

38. The freshness tracking, monitoring, and lifespan adjusting method of claim 31, wherein the changing the item's default profile lifespan adjusts in accordance with a modified default profile derived from the item's default profile and results in the extension or shortening of the item's useful life.

39. The shortening the item's useful life of claim 38, wherein the item is marked with an item classification from a group consisting of reduced useful life, mutated state, transform and consume, transform and integrate, not fit for human consumption, and unusable.

40. The freshness tracking, monitoring, and lifespan adjusting method of claim 31, wherein the registering the item to configure its default profile involves assigning an alternative identity and masking the item's true identity for others than the item's owner.

41. The freshness tracking, monitoring, and lifespan adjusting method of claim 31, wherein the changing the item's lifespan length in reference to reported deviations from the item's default profile corresponds to at least one business logic rule selected from a group consisting of friend/foe, minimum/maximum quantity rule, and minimum/maximum common environment parameter.

42. The freshness tracking, monitoring, and lifespan adjusting method of claim 31, wherein the reporting is registered with the container control device monitoring unit, the remote central server, a container control device monitoring unit interface device, and with at least one container control device monitoring unit coupled audiovisual alert device.

43. The freshness tracking, monitoring, and lifespan adjusting method of claim 31, wherein the plurality of reporting means is at least one from a group consisting of legible word text, graphics, voice, sound, alarm, lights, mechanical flags, semaphores, wired or wireless transmission to a remote container control device monitoring units, container control device monitoring unit interface device, and to the remote central server.
